(19) United States
(12) Patent Application Publication
(10) Pub. No.: US 2013/0054499 A1
(43) Pub. Date: Feb. 28, 2013

(54) APPARATUS AND METHOD FOR PROVIDING DIGITAL MIND SERVICE

(71) Applicants: Jin Young MOON, Daejeon (KR); Hyung Jik Lee, Daejeon (KR); Chang Seok Bae, Daejeon (KR); Sung Won Sohn, Daejeon (KR)

(72) Inventors: Jin Young MOON, Daejeon (KR); Hyung Jik Lee, Daejeon (KR); Chang Seok Bae, Daejeon (KR); Sung Won Sohn, Daejeon (KR)

(73) Assignee: ELECTRONICS AND TELECOMMUNICATIONS RESEARCH INSTITUTE, Daejeon (KR)

(21) Appl. No.: 13/534,589

(22) Filed: Jun. 27, 2012

(30) Foreign Application Priority Data
Aug. 24, 2011 (KR) 10-2011-0084527

(51) Int. Cl. G06F 15/18

(52) U.S. Cl. 706/13

(57) ABSTRACT

An apparatus for providing a digital mind service, includes a mind input module configured to receive gaze trace information, sensitivity information, or log information of a user. Further, the apparatus for providing the digital mind service includes a mind epigenomic map creating module configured to create a plurality of mind epigenomes in accordance with predetermined specifications by analyzing the log information of the user and to create a mind epigenomic map by defining relationship between the created mind epigenomes and structure thereof.

### CROSS-REFERENCE TO RELATED APPLICATIONS

The present invention claims priority of Korean Patent Application No. 10-2011-0084527, filed on Aug. 24, 2011 which is incorporated herein by reference.

### FIELD OF THE INVENTION

The present invention relates to apparatus and method for providing a digital mind service; and more particularly to the apparatus and method for providing the digital mind service, which are capable of representing human mind of a user into a digitized mind epigenomic map and reproducing mind of the user by transplanting the mind epigenomic map created by analyzing a log of the user to another system.

### BACKGROUND OF THE INVENTION

Artificial intelligence provides concept and method that simulate intellectual acts of a human, using a computer. Researches have been conducted in the fields of a nerve network, fuzzy, pattern recognition, an expert system, natural language, computer vision, and the like, in order to implement the intellectual process of a human which is composed of learning, inferring, and correcting, with a computer. However, the artificial intelligence is not enough to represent the mental part of a human. It is necessary to structurally represent the entire mind based on the reason, knowledge, intention, and interest, as well as intelligence based on knowledge or sensitivity studied in recent years.

The user profiling or user modeling technology that describes the interest or preference of a user is a technology that estimates the next act of the user or recommends a user preferred item that by modeling the user for a specific field, such as webpage access, click pattern, and an act of purchasing a product.

The user modeling technology described above only estimates the next act on the basis of the log of the user, but does not consider which mind components reveal a specific mind through competition or suppression, through which recognition process in the actual mind of a human.

### SUMMARY OF THE INVENTION

In view of the above, the present invention provides apparatus and method for providing digital mind service which are capable of representing a mind of a user into a digitized mind epigenomic map by analyzing the information of the user, such as gaze trace information, sensitivity information, log information of the user, and the like, and outputting a mind epigenome revealed on the basis of the represented mind epigenomic map through an act.

In accordance with a first aspect of the present invention, there is provided an apparatus for providing a digital mind service including: a mind input module configured to receive gaze trace information, sensitivity information, or log information of a user; and a mind epigenomic map creating module configured to create a plurality of mind epigenomes in accordance with predetermined specifications by analyzing the log information of the user and to create a mind epigenomic map by defining relationship between the created mind epigenomes and structure thereof.

In accordance with a second aspect of the present invention, there is provided a method for providing a digital mind service including: receiving gaze trace information, sensitivity information, or log information of a user; creating a plurality of mind epigenomes in accordance with predetermined specifications by analyzing the received gaze trace information, sensitivity information, or log information of a user the user to create a mind epigenomic map by defining relationship between the created mind epigenomes and structure thereof;

In accordance with the present invention, human mind of a user is represented into a digitized mind epigenomic map, mind of the user therein is stored in the storage unit, and the mind of the user is transplanted to another system, thereby implementing a system having the same mind as the user.

Further, when the mind is reproduced to a robot or a virtual agent in a virtual environment, it is possible to perform simulation estimating which action pattern the user shows in a specific environment, to create a cyber character modeled through the user in the real word in a virtual space or augmented reality, or to perform specific works instead of the user, such as taking care of a child, shopping, and a simple office work such as news scrap.

### BRIEF DESCRIPTION OF THE DRAWINGS

The objects and features of the present invention will be more apparent from the following detailed description taken in conjunction with the accompanying drawings, in which:

FIG. 1 is a block diagram illustrating an apparatus for a digital mind service in accordance with an embodiment of the present invention; and

FIG. 2 is a flow chart illustrating a process of providing a human mind service in accordance with an embodiment of the present invention.

### DETAILED DESCRIPTION OF THE EMBODIMENTS

Embodiments of the present invention will be described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms should be defined throughout the description of the present invention.

Combinations of each step in respective blocks of block diagrams and a sequence diagram attached herein may be carried out by computer program instructions. Since the computer program instructions may be loaded in processors of a general purpose computer, a special purpose computer, or other programmable data processing apparatus, the instructions, carried out by the processor of the computer or other programmable data processing apparatus, create devices for performing functions described in the respective blocks of the block diagrams or in the respective steps of the sequence diagram.

Since the computer program instructions, in order to implement functions in specific manner, may be stored in a memory useable or readable by a computer aiming for a computer or other programmable data processing apparatus, the instruction stored in the memory useable or readable by a computer may produce manufacturing items including an instruction device for performing functions described in the respective blocks of the block diagrams and in the respective steps of the sequence diagram. Since the computer program instructions may be loaded in a computer or other programmable data processing apparatus, instructions, a series of processing steps of which is executed in a computer or other programmable data processing apparatus to create processes executed by a computer so as to operate a computer or other programmable data processing apparatus, may provide steps for executing functions described in the respective blocks of the block diagrams and the respective sequences of the sequence diagram.

Moreover, the respective blocks or the respective sequences may indicate modules, segments, or some of codes including at least one executable instruction for executing a specific logical function(s). In several alternative embodiments, is noticed that functions described in the blocks or the sequences may run out of order. For example, two successive blocks and sequences may be substantially executed simultaneously or often in reverse order according to corresponding functions.

Hereinafter, embodiments of the present invention will be described with reference to the accompanying drawings which form a part hereof.

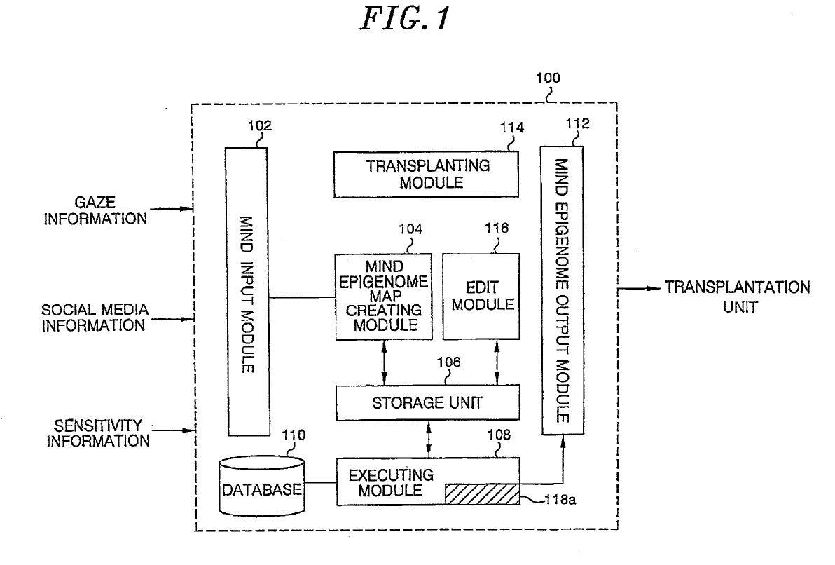

FIG. 1 is a block diagram illustrating an apparatus for a human mind service in accordance with an embodiment of the present invention, that is, an apparatus for representing human mind including reason, sensitivity, intention, interest, knowledge of a user, and the like into a mind epigenomic map. The apparatus 100 for a human mind service can be not only stored as a recording medium in a storage unit, such as a hard disk or a USB memory, but also transplanted to a transplantation unit.

As shown in FIG. 1, an apparatus 100 for providing a human mind service in accordance with an embodiment of the present invention includes a mind input module 102, a mind epigenomic map creating module 104, a storage unit 106, an executing module 108, a database 110, a mind epigenome output module 112, a transplanting module 114, and an edit module 116.

The mind input module 102 receives information for creating a mind epigenomic map, i.e., gaze trace information on a user, social media information created by SNS (Social Network Service), such as Twitter or Facebook, sensitivity information, web access record, and a variety of log information of a user, such as purchase information on a shopping mall. The received information is provided to the mind epigenomic map creating module 104.

The mind input module 102 has an open structure to be able to receive a variety of information through an open API (Application Programming Interface). Specifically, the mind input module 102 is connected with, e.g., a web server (not shown) that the user has joined, or a device (not shown), which manages the Twitter or the Facebook that the user has joined, and the like, through the open API so that the mind input module 102 receives information for creating a mind epigenomic map.

The mind epigenomic map creating module 104 creates a mind epigenomic map in accordance with predetermined specifications by analyzing the information received through the mind input module 102. Specifically, the mind epigenomic map creating module 104 creates a plurality of mind epigenomes in accordance with predetermined specifications by analyzing the log information of the user. Then, the mind epigenomic map creating module 104 creates a mind epigenomic map by defining relationship between the created mind epigenomes and structure thereof. For example, when representing the mind epigenomic map into XML, the mind epigenomic map creating module 104 creates a mind epigenomic map by defining a schema such as internal root node, specific components, and properties of the mind epigenomic map.

The mind epigenomic map created as described above includes a plurality of mind epigenomes according to the peripheral environment and a gaze or sensitivity state of a user and is stored in the storage unit 106. Here, the mind epigenome represents a component constituting the mind of a user such as knowledge, sensitivity, reason, intention and interest and the like.

The executing module 108 executes the mind epigenome in the mind epigenomic map in consideration of the peripheral environment, the sensitivity state and gaze of the user, and the database 110. Here, the database 110 stores information extended from the mind of the user such as knowledge, sensitivity, reason, intention and interest and the like.

Further, the executing module 108 further includes a mind epigenome revelation and suppression module 118a, which executes a mind epigenome suitable for a specific environment by performing revelation and suppression between mind epigenomes in accordance with a control mechanism in the specific environment in consideration of the data base 110.

The mind epigenome revealed by the executing module 108 is represented as a detailed act such as visual attention including gaze movement of a transplantation unit, expression of sensitivity, gesture, and expression through a social media through the mind epigenome output module 112.

That transplanting module 114 is provided to transplant the apparatus 100 for providing a human mind service having the configuration described above to a transplantation unit. That is, the apparatus 100 for providing the human mind service may be transplanted to a separate transplantation unit such as a storage unit including a USB memory, and another system connected through a network, e.g., a robot or a cyber character.

The edit module 116 provides an interface that makes it possible to edit the mind epigenomic map created by the mind epigenomic map creating module 104. More specifically, the edit module 116 provides an interface for setting and creating the structural relationship, components, property values, and the like of the mind epigenomic map and updates the mind epigenomic map or creates a new mind epigenomic map on the basis of the information inputted through the interface. The new mind epigenomic map is created on the basis of information set by the user without using the information inputted through the mind input module 102.

Further, the apparatus 100 for the human mind service in accordance with an embodiment of the present invention provides an interactive protocol (not illustrated) that can operate with an open API for creating the mind epigenomic map.

In accordance with the embodiment of the present invention, mind of the user is represented into a digitized mind epigenomic map, the mind of the user therein is stored in the storage unit, and the mind of the user is transplanted to another system, thereby implementing a system having the same mind as the user.

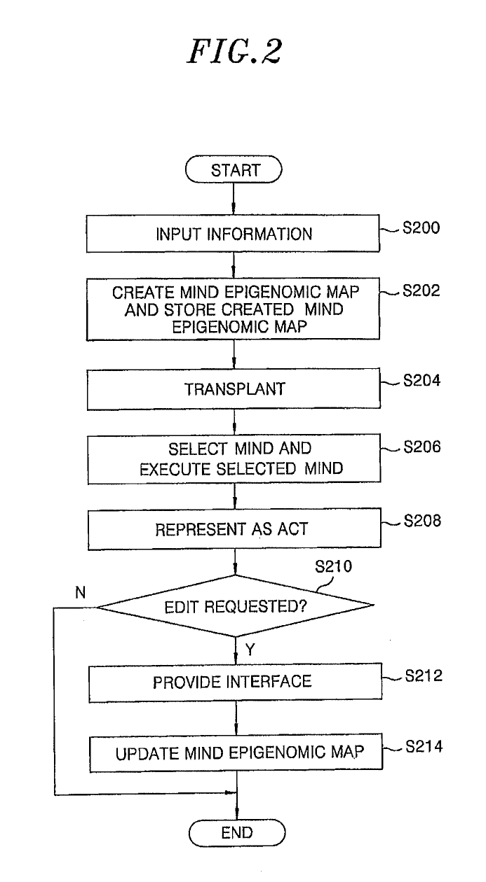

The process of operation of the apparatus 100 for providing a human mind service having the configuration described above will be described with reference to FIG. 2.

FIG. 2 is a flow chart illustrating a process of providing a human mind service in accordance with an embodiment of the present invention.

As shown in FIG. 2, in step S200, the mind input module 102 of the apparatus 100 for a human mind service receives a variety of log information of a user, such as the gaze trace information of the user, social media created by SNS such as Twitter or Facebook, sensitivity information, web access record, and purchase information on a shopping mall, and provides the received log information of the user to the mind epigenomic map creating module 104.

In step S202, the mind epigenomic map creating module 104 creates a plurality of mind epigenomes in accordance with predetermined specifications by analyzing the log information of the user. Then, the mind epigenomic map creating module 104 creates a mind epigenomic map by defining relationship between the created mind epigenomes and structure thereof, and stores the created mind epigenomic map to the storage unit 106.

Next, in step S204, the apparatus 100 for providing the human mind service that creates the mind epigenomic map is transplanted to a transplantation unit, e.g., a separate transplantation unit such as a storage unit including a USB memory, and another system connected through a network, e.g., a robot or a cyber character.

Thereafter, in step S206, as the peripheral environment and gaze information of the transplantation unit is inputted, the executing module 108 selects a mind epigenome from the created mind epigenomic map and execute the selected mind epigenome on the basis of the inputted information and the information stored in the database 110. The executing module 108 executes the mind epigenome in this process by performing revelation and suppression between the mind epigenomes in accordance with the control mechanism in a specific environment.

In step S208, The mind epigenome selected and executed by the executing module 108 is represented as a detailed act by the mind epigenome output module 112, that is, the mind epigenome may be represented as a detailed act such as visual attention including gaze movement of the transplantation unit, expression of sensitivity, gesture, and expression through a social media.

Further, when there is a request for editing the mind epigenomic map from the outside in step S210, the edit module 116 provides an interface that makes it possible to edit the mind epigenomic map stored in the storage unit 106 in step S212 and updates the mind epigenomic map on the basis of the information inputted through the interface in step S214.

In accordance with an embodiment of the present invention, it is possible to implement a system having the same mind as a user by representing the mind of a user into a digitized mine epigenomic map and transplanting the mind of the user to a transplantation unit such as a robot or a cyber character in a virtual space.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for providing a digital mind service comprising:
a mind input module configured to receive gaze trace information, sensitivity information, or log information of a user; and
a mind epigenomic map creating module configured to create a plurality of mind epigenomes in accordance with predetermined specifications by analyzing the log information of the user and to create a mind epigenomic map by defining relationship between the created mind epigenomes and structure thereof.

2. The apparatus of claim 1, further comprising:
an executing module configured to select a mind epigenome in the mind epigenomic map and execute the selected mind epigenome in accordance with the peripheral environment or gaze information of a separate transplantation unit where the digital mind service apparatus is transplanted; and
a mind epigenome output module configured to allow the mind epigenome to be represented as a detailed act.

3. The apparatus of claim 2, wherein the executing module includes mind epigenomic revelation and suppression module configured to execute a mind epigenome suitable for a specific environment by performing revelation and suppression between the mind epigenomes in accordance with a control mechanism in the specific environment.

4. The apparatus of claim 2, wherein the mind epigenome output module configured to allow the mind epigenome to be represented as a detailed act such as visual attention according to gaze movement of the separate transplantation unit, sensitivity expression, gesture, or expression through a social media.

5. The apparatus of claim 1, further comprising an edit module configured to provide an interface that allows editing the mind epigenomic map created by the mind epigenomic map creating module.

6. The apparatus of claim 5, wherein the edit module is configured to provide an interface that allows inputting information for creating a new mind epigenomic map, and
the mind epigenomic map creating module is configured to create the new mind epigenomic map on the basis of the information inputted through the interface.

7. A method for providing a digital mind service comprising:
receiving gaze trace information, sensitivity information, or log information of a user;
creating a plurality of mind epigenomes in accordance with predetermined specifications by analyzing the received gaze trace information, sensitivity information, or log information of a user the user to create a mind epigenomic map by defining relationship between the created mind epigenomes and structure thereof;
transplanting the apparatus that the mind epigenomic map is stored to a separate transplantation unit;
selecting a mind epigenome in the mind epigenomic map to execute the selected mind epigenome in accordance with the peripheral environment and gaze information of the separate transplantation unit ; and
allowing the mind epigenome to be outputted as a detailed act.

8. The method of claim 7, wherein said executing the selected mind epigenome further includes executing a mind epigenome suitable for a specific environment by performing revelation and suppression between the mind epigenomes in accordance with a control mechanism in the specific environment.

9. The method of claim 7, wherein said allowing the mind epigenome to be represented as a detailed act is performed such that the mind epigenome is represented as a detailed act such as visual attention according to gaze movement of the separate transplantation unit, sensitivity expression, gesture, or expression through a social media.

10. The method of claim 7, further comprising providing an interface that allows editing the created mind epigenomic map.

11. The method of claim 7, further comprising:
providing an interface that allows inputting information for creating a new mind genomic map; and
creating the new mind epigenomic map on the basis of the information inputted through the interface.
